(19) United States
(12) Patent Application Publication
(10) Pub. No.: US 2014/0169624 A1
(43) Pub. Date: Jun. 19, 2014

(54) IMAGE BASED PEDESTRIAN SENSING APPARATUS AND METHOD

(71) Applicant: HYUNDAI MOTOR COMPANY, Seoul (KR)

(72) Inventor: Ho Choul Jung, Suwon (KR)

(73) Assignee: HYUNDAI MOTOR COMPANY, Seoul (KR)

(21) Appl. No.: 13/889,640

(22) Filed: May 8, 2013

(30) Foreign Application Priority Data
Dec. 14, 2012 (KR) 10-2012-0146568

(51) Int. Cl. G06K 9/00

(52) U.S. Cl. CPC G06K 9/00805
USPC 382/103

(57) ABSTRACT

An image based pedestrian sensing apparatus and method that rapidly senses a pedestrian within an image by setting a region of interest (ROI) corresponding to a size of an object in a front image of a vehicle (i.e., an image taken from in front of the vehicle), extracting pedestrian candidates based on motion of the object, and sequentially comparing the extracted pedestrian candidates with pedestrian feature databases (e.g., databases for each posture of the pedestrian) according to a distance to judge the pedestrian.

### CROSS-REFERENCE TO RELATED APPLICATION

This application is based on and claims priority from Korean Patent Application No. 10-2012-0146568, filed on Dec. 14, 2012 in the Korean Intellectual Property Office, the disclosure of which is incorporated herein in its entirety by reference.

### BACKGROUND

1. Field of the Invention

The present invention relates to an image based pedestrian sensing apparatus and method, and more particularly, to a technology of sensing a pedestrian in consideration of a pedestrian feature according to a distance.

2. Description of the Prior Art

Due to popularization of the automobile, which has become a daily necessity for most families and an increase in traffic accidents, in accordance with a desire of consumers for a safer and more intelligent automobile and the developmental trend of an automotive related industry, an intelligent safety systems have been develop with insure a stable driving environment even in snow, fog, heavy rain, or the like.

One exemplary safety feature is a lane departure apparatus that prevents lane departure when a vehicle is drifting in to another lane. Additionally, devices have also been developed to prevent drowsy driving as well as preventing collision by maintaining a vehicle at a safe distance.

As vehicles become more and more quiet, one of the more popular safety features that have begun to be implemented in vehicles is a pedestrian sensing apparatus which senses and displays pedestrians which are in front or behind the vehicle.

However, these prior systems simply uses an infrared ray to detect the pedestrian or detects the pedestrian within an image without considering any features associated with the pedestrian based on the pedestrian's distance at the time of sensing the pedestrian through image recognition. As such, a large amount of calculation and time are required to execute these operations.

### SUMMARY

Accordingly, the present invention has been made to solve the above-mentioned problems occurring in the prior art while advantages achieved by the prior art are maintained intact.

One subject to be achieved by the present invention is to provide an image based pedestrian sensing apparatus and method capable of more rapidly sensing a pedestrian within an image by setting a region of interest (ROI) corresponding to a size of an object in a front image of a vehicle (i.e., an image taken of the area in front of the vehicle), extracting pedestrian candidates based on motion of the object, and sequentially comparing the extracted pedestrian candidates with pedestrian feature databases (e.g., databases for each posture of the pedestrian) according to a distance to identify the pedestrian.

In one aspect of the present invention, there is provided an image based pedestrian sensing apparatus, including: a controller that includes an image inputting unit configured to receive a front image of a vehicle; a region of interest (ROI) setting unit configured set an ROI corresponding to a size of an object in the image received through the image inputting unit; a candidate extracting unit configured to extract pedestrian candidates based on motion of the object having the ROI set by the ROI setting unit; and a pedestrian judging unit configured to compare the pedestrian candidates extracted by the candidate extracting unit with databases for each posture of a pedestrian to identify the pedestrian.

In another aspect of the present invention, there is provided an image based pedestrian sensing method, including: receiving, by an image inputting unit within a controller, a front image of a vehicle; setting, by an ROI setting unit within the controller, an ROI corresponding to a size of an object in the received front image; extracting, by a candidate extracting unit within the controller, pedestrian candidates based on motion of the object having the set ROI; and comparing, by a pedestrian judging unit within the controller, the extracted pedestrian candidates with databases for each posture of a pedestrian to judge the pedestrian.

### BRIEF DESCRIPTION OF THE DRAWINGS

The above and other objects, features and advantages of the present invention will be more apparent from the following detailed description taken in conjunction with the accompanying drawings, in which:

FIG. 1 is a configuration diagram of an image based pedestrian sensing apparatus according to an exemplary embodiment of the present invention;

FIG. 2 is an illustrative diagram of a process of setting a region of interest (ROI) according to the exemplary embodiment of the present invention; and

FIG. 3 is a flow chart of an image based pedestrian sensing method according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Additionally, it is understood that the below methods are executed by at least one controller. The term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, an exemplary embodiment of the present invention will be described in detail with reference to the accompanying drawings.

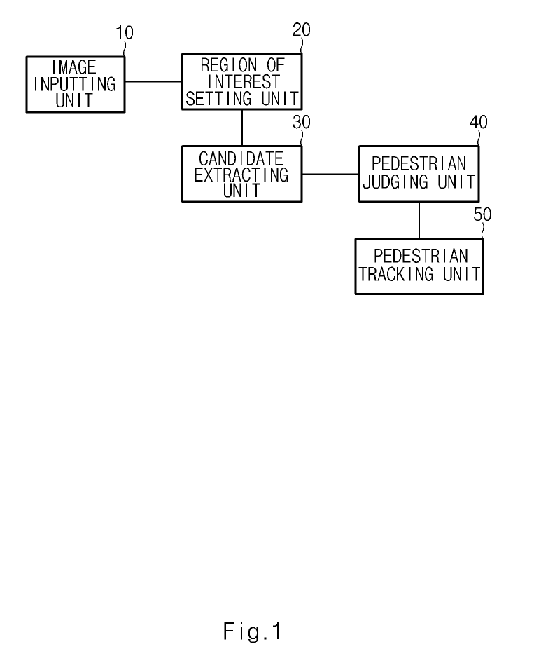

FIG. 1 is a configuration diagram of an image based pedestrian sensing apparatus according to an exemplary embodiment of the present invention. As shown in FIG. 1, the image based pedestrian sensing apparatus according to the exemplary embodiment of the present invention includes a controller that embodies an image inputting unit 10, a region of interest (ROI) setting unit 20, a candidate extracting unit 30, a pedestrian judging unit 40, and a pedestrian tracking unit 50.

As stated above, the above-mentioned respective units may be implemented in a controller, such as an electronic control unit (ECU) of a vehicle. Although the above-mentioned respective units are implemented as a plurality of units in multiple controllers in the embodiment of the present invention, they may also be implemented to be integrated in the ECU.

First, the image inputting unit 10 receives an image acquired by an imaging device (e.g., camera) that photographs the front of the vehicle. The ROI setting unit 20 is configured to set an ROI corresponding to a size of an object in the front image of the vehicle received through the image inputting unit 10. That is, the ROI setting unit 20 calculates a size (e.g., height) of the pedestrian at a bottom position (i) of a pedestrian region in the image using installation environment informations (H_{C}, θ_{IB}, and D_{IB}) of the imaging device, a imaging device specification ( ) and an actual size ( ) of the pedestrian. Therefore, since the pedestrian may be identified based on the number of pixels, the minimum and maximum sizes of the pedestrian from the bottom position of the pedestrian region can be represented to the ROI setting unit 20 so that the ROI setting unit 20 can set an appropriate ROI (e.g., detection window).

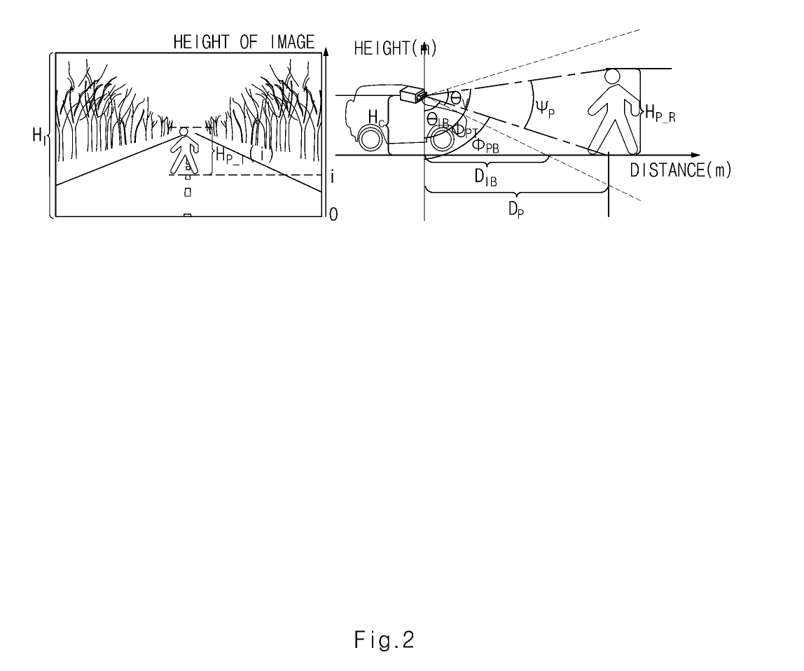

Referring to FIG. 2, a relationship between installation environment information of the imaging device may be represented by the following Equation 1.

$${H}_{P\_I} ( i ) = \frac{{ψ}_{P} ( i )}{{θ}_{V}} \times {H}_{I} \\ {ψ}_{P} ( i ) = {φ}_{PT} ( i ) - {φ}_{PB} ( i ) \\ {φ}_{PT} ( i ) = \{ \begin{matrix}arctan ( \frac{{H}_{P\_R} - {H}_{C}}{{D}_{P} ( i )} ) + 90 ° & if {H}_{C} < {H}_{P\_R} \\ 90 ° - arctan ( \frac{{H}_{C} - {H}_{P\_R}}{{D}_{P} ( i )} ) & otherwise\end{matrix} \\ {D}_{P} ( i ) = tan ( {φ}_{PB} ( i ) ) \times {H}_{C} \\ {φ}_{PB} ( i ) = i \times \frac{{θ}_{V}}{{H}_{I}} + {θ}_{IB} \\ {θ}_{IB} = arctan ( \frac{{D}_{IB}}{{H}_{C}} ) \qquad [ Equation 1 ]$$

i: a bottom position of a pedestrian region in an image
H_{P}_{_{—}}_{I}: a size (height) of a pedestrian region in an image
ψ_{P}: an angle in a vertical direction occupied by a pedestrian
H_{I}: a size (height) of an input image
φ_{PT}: an angle up to the end of a pedestrian head
φ_{PB}: an angle to the end of a pedestrian toe
H_{P}_{_{—}}_{R}: a size (height) of a pedestrian
D_{P}: a distance up to a pedestrian
H_{C}: a height at which a camera is installed
θ_{V}: an angle of view in a vertical direction of a camera
θ_{IB}: an angle up to an actual position corresponding to a start point of an image
D_{IB}: a distance up to an actual position corresponding to a start point of an image

Next, the candidate extracting unit 30 extracts the pedestrian candidates based on motion of the object having an ROI set by the ROI setting unit 20. The pedestrian judging unit 40 sequentially compares the pedestrian candidates extracted by the candidate extracting unit 30 with pedestrian feature databases according to a distance, that is, databases for each posture of the pedestrian to identify the pedestrian. That is, although not shown in the accompanying drawings, the pedestrian judging unit 40 includes a front database storing feature information (e.g., vector information) related to the front side of the pedestrian, a rear database stores feature information related to the rear side of the pedestrian, a left database stores feature information relating to the left side of the pedestrian, a right database stores feature information relating to the right side of the pedestrian, a left upper half database stores feature information on the left upper half of the pedestrian, and a right upper half database stores feature information on the right upper half of the pedestrian, as the databases for each posture of the pedestrian. Therefore, the pedestrian judging unit 40 sequentially (e.g., in a cascade scheme) compares the feature information relating to the pedestrian candidates extracted by the candidate extracting unit 30 with the respective databases described above to judge the pedestrian.

For example, it is preferable that a sequence of the databases compared with the feature information on the pedestrian candidates is a sequence of the front database, the rear database, the left database, the right database, the left upper half database, and the right upper half database, but is not limited thereto. The pedestrian tracking unit 50, which is an additional unit, may track the pedestrian identified by the pedestrian judging unit 40. For example, the pedestrian tracking unit 50 tracks the pedestrian based on the number of feature points of the pedestrian within the ROI.

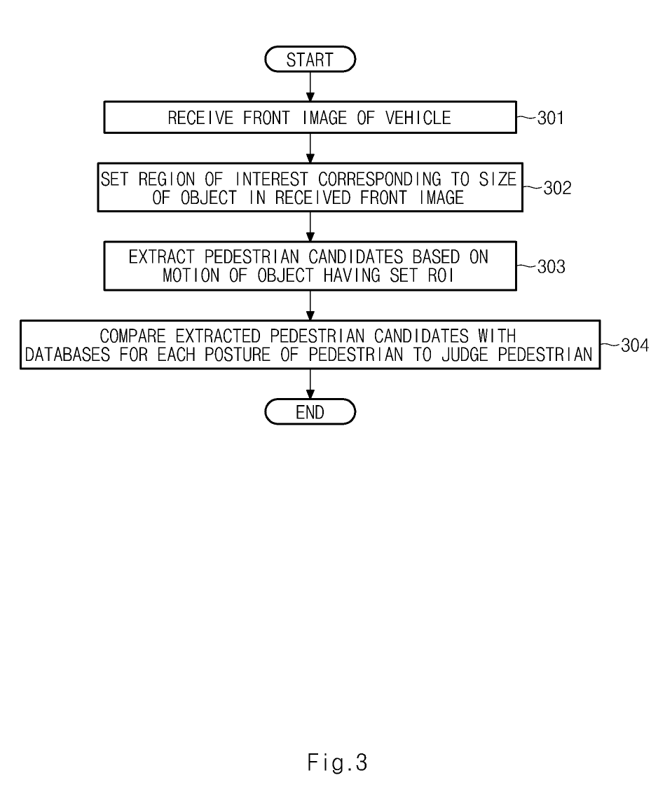

FIG. 3 is a flow chart of an image based pedestrian sensing method according to the exemplary embodiment of the present invention. First, the image inputting unit 10 receives the front image of the vehicle (301). Then, the ROI setting unit 20 sets the ROI corresponding to the size of the object in the received front image (302). Next, the candidate extracting unit 30 extracts the pedestrian candidates based on the motion of the object having the set ROI (303), and the pedestrian judging unit 40 compares the extracted pedestrian candidates with the databases for each posture of the pedestrian to identify the pedestrian (304). Additionally, a pedestrian tracking unit 50 may extract the pedestrian and display the pedestrian to the driver.

Through the above-mentioned process, the pedestrian may be more rapidly sensed within the image.

As set forth above, according to the exemplary embodiment of the present invention, the region of interest corresponding to the size of the object is set in the front images of the vehicle, the pedestrian candidates are extracted based on the motion of the object, the extracted pedestrian candidates are sequentially compared with the pedestrian feature databases (e.g., databases for each posture of the pedestrian) according to the distance to identify the pedestrian, thereby making it possible to more rapidly sense the pedestrian within the image.

What is claimed is:

1. An image based pedestrian sensing apparatus comprising:
one or more controllers including:
an image inputting unit configured to receive a front image of a vehicle;
a region of interest (ROI) setting unit configured to set an ROI corresponding to a size of an object in the image received through the image inputting unit;
a candidate extracting unit configured to extract pedestrian candidates based on motion of the object having the ROI set by the ROI setting unit; and
a pedestrian judging unit configured to compare the pedestrian candidates extracted by the candidate extracting unit with databases for each posture of a pedestrian to identify the pedestrian.

2. The apparatus according to claim 1, wherein the pedestrian judging unit includes at least one of a front database, a rear database, a left database, a right database, a left upper half database, and a right upper half database, as the databases for each posture of the pedestrian.

3. The apparatus according to claim 2, wherein the pedestrian judging unit is configured to compare the pedestrian candidates extracted by the candidate extracting unit with the front database, the rear database, the left database, the right database, the left upper half database, and the right upper half database in a cascade scheme.

4. The apparatus according to claim 1, further comprising a pedestrian tracking unit configured to track the pedestrian identified by the pedestrian judging unit.

5. The apparatus according to claim 4, wherein the pedestrian tracking unit is configured to track the pedestrian based on the number of feature points of the pedestrian within the ROI.

6. An image based pedestrian sensing method comprising:
receiving, by an image inputting unit within a controller, a front image of a vehicle;
setting, by an ROI setting unit within the controller, an ROI corresponding to a size of an object in the received front image;
extracting, by a candidate extracting unit within the controller, pedestrian candidates based on motion of the object having the set ROI; and
comparing, by a pedestrian judging unit within the controller, the extracted pedestrian candidates with databases for each posture of a pedestrian to identify the pedestrian.

7. The method according to claim 6, wherein the databases for each posture of the pedestrian includes at least one of a front database, a rear database, a left database, a right database, a left upper half database, and a right upper half database.

8. The method according to claim 7, wherein while identifying the pedestrian, the pedestrian candidates extracted by the candidate extracting unit are compared with the front database, the rear database, the left database, the right database, the left upper half database, and the right upper half database in a cascade scheme.

9. The method according to claim 6, further comprising tracking, by a pedestrian tracking unit, the pedestrian identified by the pedestrian judging unit.

10. The method according to claim 9, wherein in the tracking of the pedestrian, the pedestrian is tracked based on the number of feature points of the pedestrian within the ROI.

11. The apparatus according to claim 6, wherein the image based pedestrian sensing apparatus method is applied to vehicles selected from a group consisting of hybrid vehicles, electric vehicles, and fuel cell vehicles.

12. A non-transitory computer readable medium containing program instructions executed by a controller, the computer readable medium comprising:
program instructions that receive a front image of a vehicle;
program instructions that set an ROI corresponding to a size of an object in the received front image;
program instructions that extract pedestrian candidates based on motion of the object having the set ROI; and
program instructions that compare the extracted pedestrian candidates with databases for each posture of a pedestrian to identify the pedestrian.

13. The non-transitory computer readable medium according to claim 12, wherein the databases for each posture of the pedestrian includes at least one of a front database, a rear database, a left database, a right database, a left upper half database, and a right upper half database.

14. The non-transitory computer readable medium according to claim 13, wherein while identifying the pedestrian, the pedestrian candidates extracted by the candidate extracting unit are compared with the front database, the rear database, the left database, the right database, the left upper half database, and the right upper half database in a cascade scheme.

15. The non-transitory computer readable medium according to claim 12, further comprising program instructions that track the pedestrian identified by the pedestrian judging unit.

16. The non-transitory computer readable medium according to claim 15, wherein program instructions that track the pedestrian are based on the number of feature points of the pedestrian within the ROI.
